(19) United States
(12) Patent Application Publication
(10) Pub. No.: US 2022/0355887 A1
(43) Pub. Date: Nov. 10, 2022

(54) HINGE ASSEMBLY FOR FOLDING CYCLE FRAME

(71) Applicant: Electric Bike Technologies Inc., Croydon, PA (US)

(72) Inventor: Jason Kraft, New Hope, PA (US)

(73) Assignee: Electric Bike Technologies Inc., Croydon, PA (US)

(21) Appl. No.: 17/686,926

(22) Filed: Mar. 4, 2022

Related U.S. Application Data
(60) Provisional application No. 63/186,260, filed on May 10, 2021.

(51) Int. Cl. B62K 15/00

(52) U.S. Cl. CPC B62K 15/006

(57) ABSTRACT

A hinge assembly for a foldable cycle frame includes a front plate member configured to be connected to a first part of the cycle frame; a rear plate member configured to be connected to a second part of the cycle frame; and a middle plate member configured to releasably couple the front plate member and the rear plate together. The hinge assembly further includes a first pin member configured to secure the front plate member to the middle plate member; and a second pin member configured to secure the rear plate member to the middle plate member.

### FIELD

The aspects of the disclosed embodiments relate to a hinge assembly for a cycle frame, and in particular, to a hinge assembly that enables the cycle frame to be one or more of folded or separated.

### BACKGROUND

Collapsible cycles, also known as folding cycles, are cycles that can be folded into a smaller form factor. This can allow for easier transport or storage of the cycle when not in use.

The stability of the frame of a cycle is an important factor due to the high loads on the bicycle frame. How to ensure the stability of the frame, yet still insure the ability to fold or separate the frame is a consideration in the design of folding cycles.

Accordingly, it would be desirable to provide a hinge assembly that addresses at least some of the problems described above.

### SUMMARY

The aspects of the disclosed embodiments are directed to a hinge assembly for a cycle frame. The hinge assembly is capable of enabling the cycle frame to be folded or separated, while still maintaining the structural integrity of the cycle frame. This and other advantages of the disclosed embodiments are provided substantially as shown in, and/or described in connection with, at least one of the figures, as set forth in the independent claims. Further advantageous modifications can be found in the dependent claims.

According to a first aspect the disclosed embodiments are directed to an apparatus. In one embodiment, the apparatus includes a hinge assembly for a cycle frame comprising a front plate member configured to be connected to a first part of the cycle frame; a rear plate member configured to be connected to a second part of the cycle frame; and a middle plate member configured to releasably couple the front plate member and the rear plate together. The hinge assembly further comprises a first pin member configured to secure the front plate member to the middle plate member; and a second pin member configured to secure the rear plate member to the middle plate member.

According to a possible implementation form the first pin member is further configured to be removed from the front plate member and the middle plate member and enable the front plate member to be separated from the middle plate member.

According to a possible implementation form the middle plate member comprises a hinge member that is configured to be coupled to a hinge member of the rear plate member and wherein a removal of the second pin member is configured to enable the rear plate member to rotate with respect to the middle plate member.

According to a possible implementation form the first pin member and the second pin member comprise spring biased ring pins.

According to a possible implementation form the rear plate member is rotatably secured to the middle plate member.

According to a possible implementation form the front plate member further comprises a flange member, the flange member configured to be received in a corresponding flange receiver of the middle plate member.

According to a possible implementation form one side of the rear plate member comprises a hinge member and an opposing side of the rear plate member comprises a receiver configured to receive the second pin member.

According to a possible implementation form one side of the front plate member comprises a receiver configured to receive the first pin member.

According to a possible implementation form one side of the middle plate member comprises a receiver configured to receive the second pin member and an opposing side of the middle plate member comprises a hinge member configured to pivotally engage with the hinge member of the rear plate member and a receiver configured to receive the first pin member.

According to a second aspect the disclosed embodiments are directed to a cycle frame assembly. In one embodiment, the cycle frame assembly includes a first frame section, a second frame section and a hinge assembly that connects the first frame section and the second frame section. The hinge assembly includes a first plate member configured to be connected to the first frame section; a third plate member configured to be connected to the second frame section; and a second plate member disposed between the first plate member and the third plate member. The second plate member is configured to releasably couple the first plate member and the third plate member together.

In a possible implementation form, the hinge assembly comprises a first pin member configured to secure the first plate member to the second plate member; and a second pin member configured to secure the third plate member to the second plate member.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which:

FIG. 1 is a perspective view of an exemplary hinge assembly incorporating aspects of the disclosed embodiments.

FIG. 2 is a front view of one side of an exemplary first plate member for a hinge assembly incorporating aspects of the disclosed embodiments.

FIG. 3 is a side view of the first plate member shown in FIG. 2.

FIG. 4 is a top view of the first plate member shown in FIG. 2.

FIG. 5 is a perspective view of one embodiment of a second or middle plate member for a hinge assembly incorporating aspects of the disclosed embodiments.

FIG. 6 is a side view of the second plate member shown in FIG. 5.

FIG. 7 is a back side view the second plate member shown in FIG. 5.

FIG. 8 is a front view of one embodiment of a third plate member for a hinge assembly incorporating aspects of the disclosed embodiments.

FIG. 9 is a top view of the third plate member shown in FIG. 8.

FIG. 10 illustrates a partially assembled hinge assembly incorporating aspects of the disclosed embodiments.

FIG. 11 illustrates the coupling of the first plate member to the second plate member for a hinge assembly incorporating aspects of the disclosed embodiments.

FIG. 12 illustrates a further example of the coupling of the first plate member to the second plate member for a hinge assembly incorporating aspects of the disclosed embodiments.

FIG. 13 is a top view of the partially assembled hinge assembly shown in FIG. 10.

FIG. 14 illustrates the first plate member coupled to the second plate member for a hinge assembly incorporating aspects of the disclosed embodiments.

FIG. 15 illustrates the coupling of the third plate member to the second plate member for a hinge assembly incorporating aspects of the disclosed embodiments.

FIG. 16 illustrates the insertion of pin members in a hinge assembly incorporating aspects of the disclosed embodiments.

FIG. 17 illustrates an exemplary cycle frame with a hinge assembly incorporating aspects of the disclosed embodiments

### DETAILED DESCRIPTION OF THE DISCLOSED EMBODIMENTS

The following detailed description illustrates exemplary aspects of the disclosed embodiments and ways in which they can be implemented. Although some modes of carrying out the aspects of the disclosed embodiments have been disclosed, those skilled in the art would recognize that other embodiments for carrying out or practising the aspects of the disclosed embodiments are also possible.

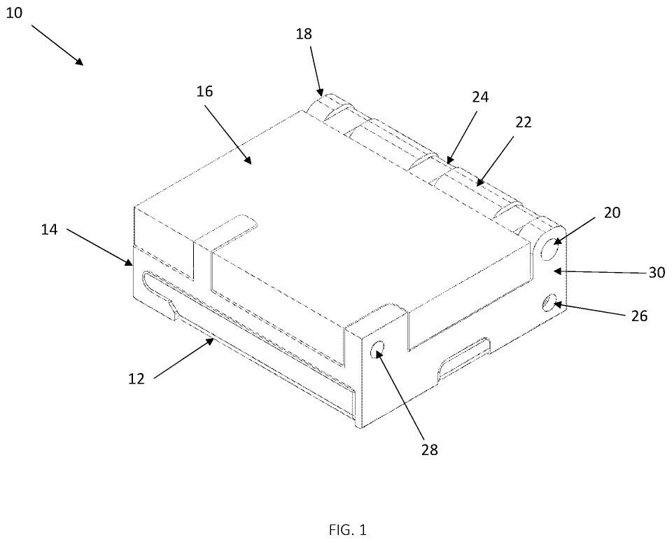

FIG. 1 illustrates an exemplary apparatus 10 incorporating aspects of the disclosed embodiments. The apparatus 10 generally comprises a hinge assembly that is interposed between two sections of a cycle frame and is configured to enable the frame to be folded and/or separated. The aspects of the disclosed embodiments enable a cycle, such as a bicycle or tricycle, to be folded or separated into two or more sections. This is advantageous when there is a need for storage or transport of a cycle, for example.

In the example of FIG. 1, the apparatus 10, which will generally be referred to as hinge assembly 10 herein, comprises a first plate or plate member 12, a second plate or plate member 14 and a third plate or plate member 16. For the purposes of the description herein, the first plate member 12 will be referred to as a “front plate or member 12”, the second member 14 as a “middle plate or member 14” and the third member 16 as a “rear plate or member 16.” The designations associated with the different plate members are merely for descriptive purposes.

As will be further described herein, in one embodiment, the front plate 12 is configured to be attached to a frame member of a cycle. The rear plate 16 is configured to be attached to another part or other side of the frame member of the cycle. In this manner, the hinge assembly 10 is secured between two parts of the frame member of the cycle.

In one embodiment, the hinge assembly 10 includes a pivot member or assembly 18. In the example of FIG. 1, the pivot member 18 pivotally connects middle plate member 14 and the rear plate member 16 about a hinge pivot pin 20.

As shown in FIG. 1, the hinge pivot pin 20 is configured to be inserted into corresponding openings of hinge members 22, 24 in the middle plate member 14 and rear plate member 16, respectively. In the example of FIG. 1, the middle plate member 14 includes four hinge members 22, while the rear plate member 16 has three hinge members 24. In alternate embodiments, the pivot member 18 can include any suitable number of hinge members 22, 24, other than that shown in FIG. 1.

In the embodiment of FIG. 1, the exemplary hinge assembly 10 also includes and opening or receiver 26 for a first pin member, and an opening or receiver 28 for a second pin member. As will be described further herein, the first pin member and the second pin member are used to secure the different plates of the hinge assembly 10 together in a releasable manner.

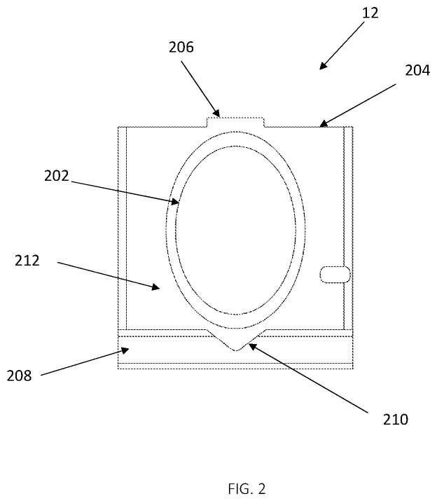

FIG. 2 illustrates a front view of one embodiment of an exemplary front plate member 12 incorporating aspects of the disclosed embodiments. In this example, the oval shape area 202 generally illustrates where the frame of the cycle can be secured to the front plate member 12, such as by welding. Although an oval shape is illustrated in the example of FIG. 2, the aspects of the disclosed embodiments are not so limited. In alternate embodiments, the shape of the connection between the front plate member 12 and the cycle frame can be any suitable geometric shape and size.

In the example of FIG. 2, a top or upper edge 204 of the front plate member 12 includes a protrusion or tab member 206. The tab member 206 is configured to be received in a complementary receiving part of the middle plate member 14, as will be further described herein.

A bottom or lower portion 208 of the front plate member 12 includes a guide member 210. The guide member 210 is configured to be received in a suitable shaped receiving part of the middle plate member 14, as will be further described herein. Both the tab member 206 and guide member 210 are configured to assist in aligning the front plate member 12 with the middle plate member 14 when the front plate member 12 is inserted and coupled to the middle plate member 14. The shapes of the members 206 and 210 shown in FIG. 2 are not intended to be limiting. In alternate embodiments, any suitable geometric shapes can be used.

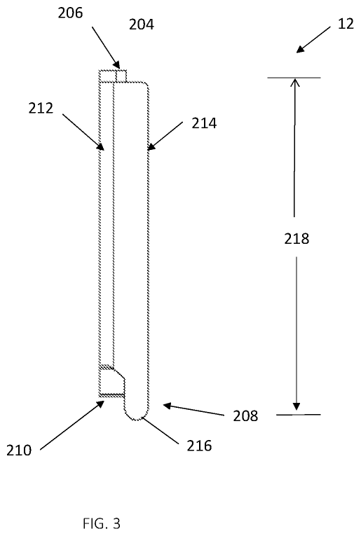

FIG. 3 illustrates a side view of the front plate member 12 of FIG. 2. As shown in this example, a width of the tab member 206 only extends across a portion of a depth of the front plate member 12, from the outside facing surface 212.

The bottom or lower portion 208 of the front plate member 12 includes a flange member 216. The flange member 216 is configured to be received in a corresponding channel member of the middle plate member 14, as well be further described herein. In the example of FIG. 3, a dimension 218, or height, of the flange member 216 is approximately 0.5 inches. In alternate embodiments, the dimension 218 of the flange member 216 can be any suitable dimension other than including 0.5 inches.

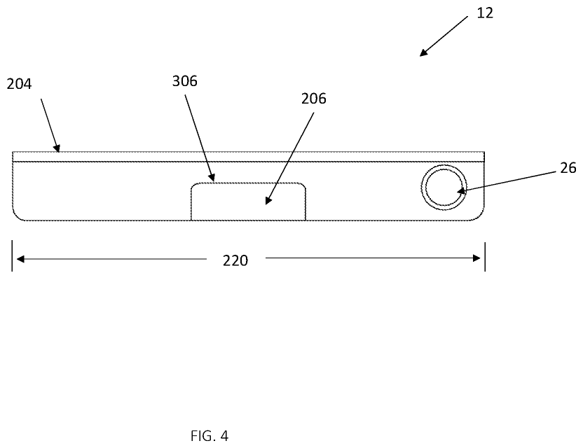

FIG. 4 is a top view of the front plate member 12. The top portion 204 of the front plate member 12 includes the tab member 206 and the first pin receiver 26. An exemplary width 220 of the front plate member is approximately 3 inches.

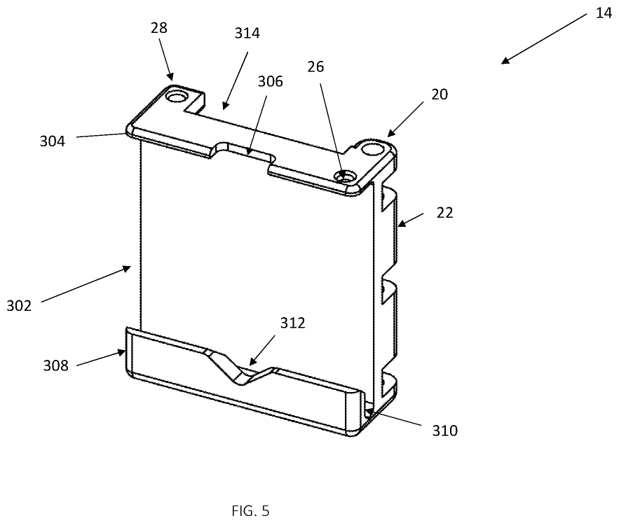

FIG. 5 illustrates a perspective front view of a middle member 14 incorporating aspects of the disclosed embodiment. As shown in this example, the front or first side 302 of the middle member 14 includes an upper edge or flange member 304 and a lower receiver member or section 308. The upper edge or flange member 304 includes a receiver section 306 that is suitably shaped and configured to receive the tab member 206 of the front plate member 12. The lower receiver member 308 includes a channel member 310 that is suitably shaped and configured to receive the flange member 216 of the front plate member 14.

As shown in FIG. 5, the first pin receiver 26 is disposed in the flange member 304 on the front side 302 of the middle plate member 14. The second pin receiver 28 is disposed on a rear facing side 314 of the middle plate member 14.

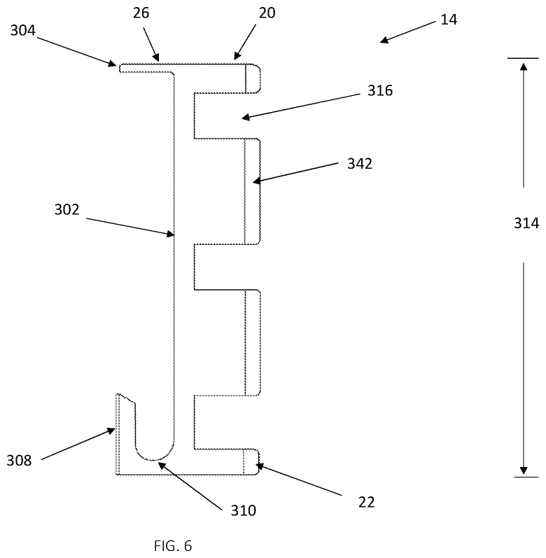

FIG. 6 is a side view of the middle plate member 14. As shown in this example, a height 314 is approximately 3.350 inches. A spacing 316 between adjacent hinge members 22 can be approximately 0.375 inches.

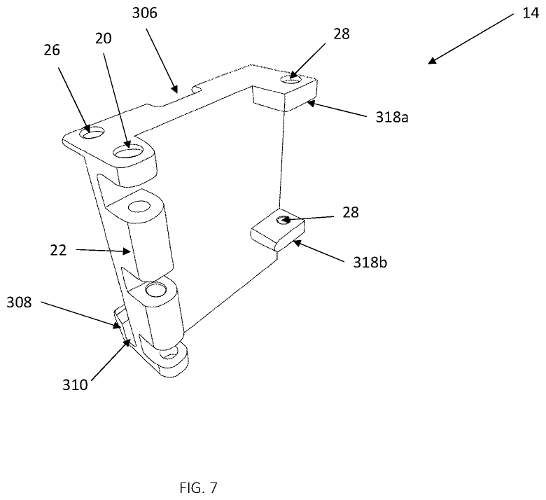

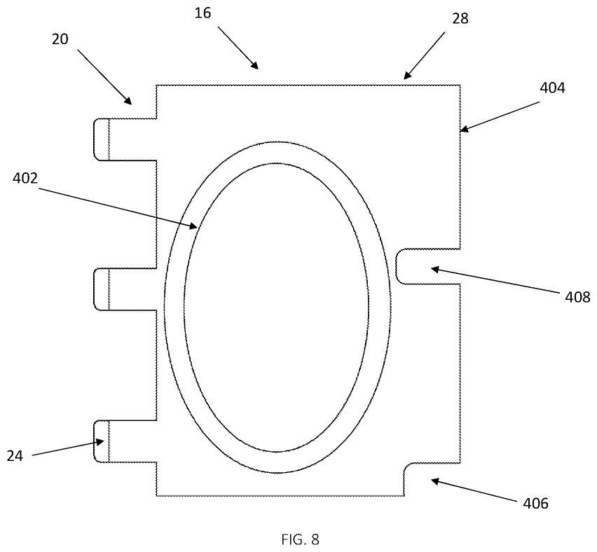

FIG. 7 is a back side view of the middle plate member 14. In the example of FIG. 7, a first tab member 318a and a second tab member 318b are illustrated. The tab members 318a, 318b are received in corresponding receivers 406, 408 in the plate member 16 illustrated in FIG. 8. The pin channel 28 runs through the tab members 318a, 318b. The tab members 318a, 318b are used to align the plate member 16 with the plate member 14 as well as lock the plate member 16 to the plate member 14 when a pin member is inserted into the pin channel 26.

FIG. 8 is a front view of one embodiment of the rear plate member 16. In this example, the oval shaped lines or area 402 illustrate where the frame member of the cycle can be secured to the rear plate member 16, such as by welding for example. The side 404 of the rear plate member 16 opposite the hinge members 24 includes two cut outs or openings 406 and 408. The openings 406 and 408 are configured to receive corresponding members 318a and 318b of the middle plate member 14 shown in FIG. 7. As shown in FIG. 8, the second pin receiver 28 traverses through the openings 406, 408.

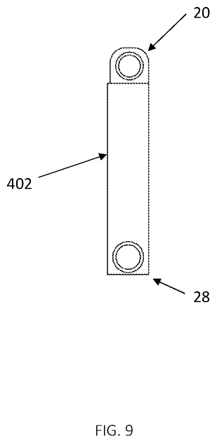

FIG. 9 is a top view of the rear plate member 16. The hinge pin receiver 20 is on one side and the second pin receiver 28 on the other side.

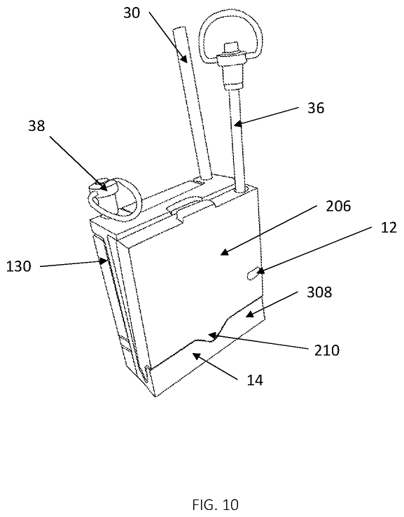

FIG. 10 is a top view of a partially assembled hinge assembly 10 incorporating aspects of the disclosed embodiments. In this example the front plate member 12 is partially inserted into the lower receiver 308 of the middle plate member 14. In this example, a hinge pin 30 is partially inserted into the hinge pin receiver 20. A first pin member 36 is partially inserted into the first pin receiver 26. A second pin member 38 is partially inserted into the second pin receiver 28. As shown in the example of FIG. 10, the first pin member 36 and the second pin member 38 include half rings or D-rings that allow the first pin member 36 and second pin member 38 to be inserted into as well as removed from their respective receivers 26, 28.

The pin members 36 and 38 can generally comprise any suitable type of pin mechanism that will remain inserted and in a locked position until pulled out. For example, in one embodiment, the pin members 36 and 38 can comprise a spring biased ring pin moving mechanism.

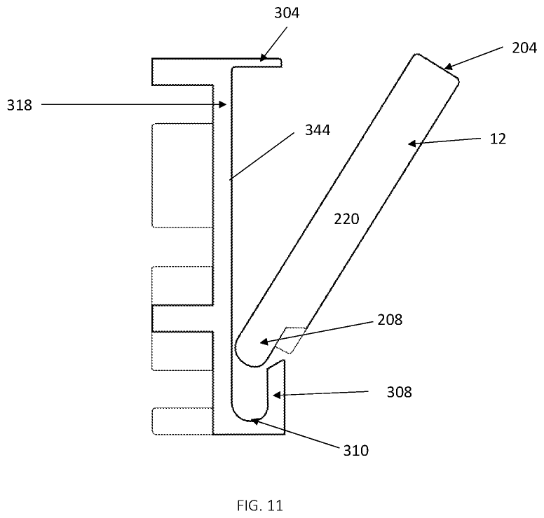

FIG. 11 illustrates the insertion of the front plate member 12 into the middle plate member 14. As shown in this example, the lower portion 208 of the front plate member 12 is received in the channel 310 of the lower portion 308 of the middle plate member 14. The front plate member 12 is generally configured to pivot into position as it is inserted into the channel 310 and against the wall 344.

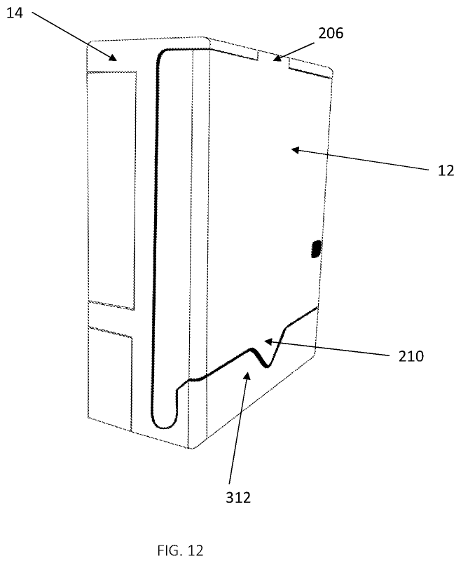

FIG. 12 illustrates a front view of the partially inserted front plate member 12.

The guide member 210 is received in the receiver 312.

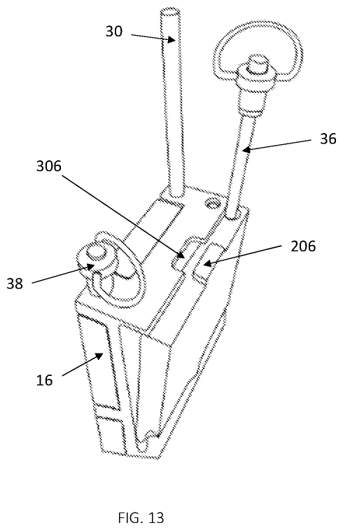

FIG. 13 is a top view of the partially inserted front plate member 12. In this example, the tab member 206 is being received in the corresponding tab member receiver 306. The rear plate 16 is shown in the coupled position in this example with the second pin member 38 being fully inserted. The hinge pin 30 and first pin member 36 are only partially inserted in example.

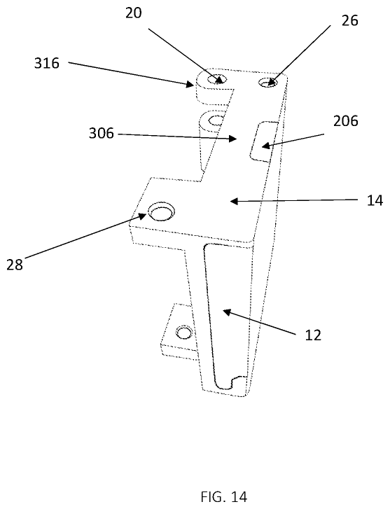

FIG. 14 illustrates the front plate member 12 being fully seated and coupled with the middle plate member 14. The rear plate member 16 is removed in this example.

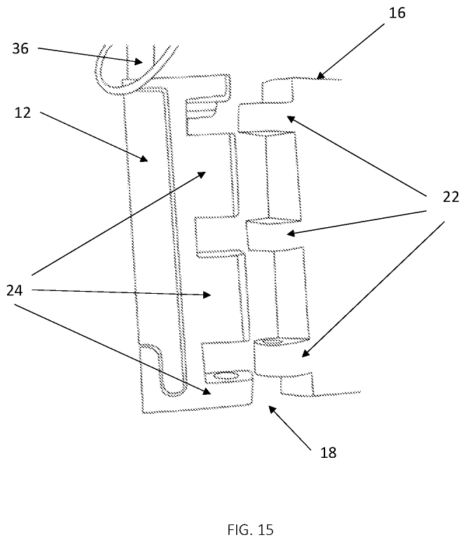

FIG. 15 illustrates the rear plate member 16 being coupled to the middle plate member 14. The hinge members 24 of the rear plate member 16 are being inserted into the corresponding openings of the hinge member assembly 18 of the middle plate member 14. The pin member 36 is shown inserted, locking the front plate member 12 to the middle plate member 14.

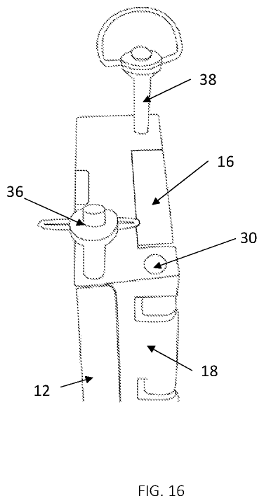

FIG. 16 illustrates the front plate member 12 coupled to the middle plate member 14 and the rear plate member 16 coupled to the middle plate member 14. In one embodiment, the removal of the second pin member 38 enables the rear plate member 16 to move or pivot about the hinge member 18. When the hinge assembly 10 is attached to the frame of a cycle, removal of the second pin member 38 enables the cycle to be folded.

Removal of the first pin member 36 enables a removal of the front plate member 12 from the middle plate member 14. When the hinge assembly 10 is attached to the frame of a cycle, this allows the respective portions of the frame to be separated from one another.

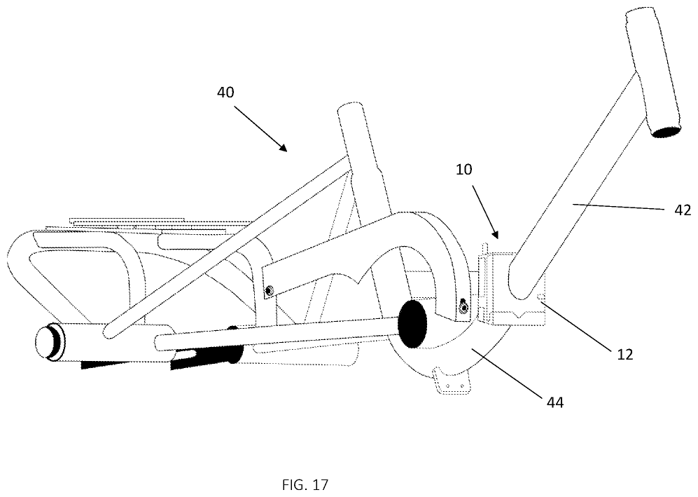

FIG. 17 illustrates an exemplary implementation of a hinge assembly 10 incorporating aspects of the disclosed embodiments. In this example, an exemplary cycle frame 40 is illustrated. The hinge assembly 10 in this example is disposed between a first portion 42 of the frame 40 and a second portion 44 of the frame 40. The front plate member 12 in this example is connected to the first or forward portion 42 of the frame 40. The rear plate member 16 is connected to the second or rear portion 44 of the frame 40. In alternate embodiments, the hinge assembly 10 be connected to the frame in any suitable manner, other than the example shown in FIG. 17.

When the pins 36 and 38 are inserted in a locked position on the hinge assembly 10, together with hinge pin 30, the frame 40 is secure and the cycle can be used in a normal fashion. If it is desired to fold the frame, in one embodiment, the second pin member 38 is removed from the hinge assembly 10. The frame members 42 and 44 will pivot about the hinge member 18.

If it is desired to separate the front frame member 42 from the rear frame member 44, the first hinge pin 36 is removed from the hinge assembly 10. This releases the front plate member 12 from the middle plate member 14. The front frame member 42 which is attached to the front plate member 12, can then be separated from the rear frame member 44, which is attached to the rear plate member 16.

In one embodiment, a material of the hinge assembly 10 is an aluminium alloy. In alternate embodiments, any suitable material can be used that provides the desired strength and weight qualities.

The aspects of the disclosed embodiments are directed to a hinge assembly for a cycle frame. The hinge assembly will connect two portions of the cycle frame, while also enable the frame to be folded or the two parts separated. The folding or separating features of the hinge assembly are enable depending on which one or more of the two removable pins are removed.

Modifications to embodiments of the aspects of the disclosed embodiments described in the foregoing are possible without departing from the scope of the aspects of the disclosed embodiments as defined by the accompanying claims. Expressions such as “including”, “comprising”, “incorporating”, “have”, “is” used to describe and claim the aspects of the disclosed embodiments are intended to be construed in a non-exclusive manner, namely allowing for items, components or elements not explicitly described also to be present. Reference to the singular is also to be construed to relate to the plural.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hinge assembly for a cycle frame comprising:
a front plate member configured to be connected to a first part of the cycle frame;
a rear plate member configured to be connected to a second part of the cycle frame; and
a middle plate member configured to releasably couple the front plate member and the rear plate together, wherein the hinge assembly further comprises:
a first pin member configured to secure the front plate member to the middle plate member; and
a second pin member configured to secure the rear plate member to the middle plate member.

2. The hinge assembly according to claim 1, wherein the first pin member is further configured to be removed from the front plate member and the middle plate member and enable the front plate member to be separated from the middle plate member.

3. The hinge assembly according to claim 1, wherein the middle plate member comprises a hinge member that is configured to be coupled to a hinge member of the rear plate member and wherein a removal of the second pin member is configured to enable the rear plate member to rotate with respect to the middle plate member.

4. The hinge assembly according to claim 1, wherein the first pin member and the second pin member comprise spring biased ring pins.

5. The hinge assembly according to claim 1, wherein the rear plate member is rotatably secured to the middle plate member.

6. The hinge assembly according to claim 1, wherein the front plate member further comprises a flange member, the flange member configured to be received in a corresponding flange receiver of the middle plate member.

7. The hinge assembly according to claim 1, wherein one side of the rear plate member comprises a hinge member and an opposing side of the rear plate member comprises a receiver configured to receive the second pin member.

8. The hinge assembly according to claim 7, wherein one side of the front plate member comprises a receiver configured to receive the first pin member.

9. The hinge assembly according to claim 8, wherein one side of the middle plate member comprises a receiver configured to receive the second pin member and an opposing side of the middle plate member comprises a hinge member configured to pivotally engage with the hinge member of the rear plate member and a receiver configured to receive the first pin member.

10. A cycle frame comprising:
a frame assembly comprising a first frame section and a second frame section; and
a hinge assembly disposed between the first frame section and the second frame section, the hinge assembly comprising:
a first plate member configured to be connected to the first frame section;
a third plate member configured to be connected to the second frame section; and
a second plate member disposed between the first plate member and the third plate member, the second plate member configured to releasably couple the first plate member and the third plate member together.

11. The cycle frame according to claim 10, wherein the hinge assembly comprises:
a first pin member configured to secure the first plate member to the second plate member; and
a second pin member configured to secure the third plate member to the second plate member.
